(19) United States
(12) Patent Application Publication
(10) Pub. No.: US 2019/0152329 A1
(43) Pub. Date: May 23, 2019

(54) CAR SHARING FEE SETTING SERVER, SYSTEM AND METHOD

(71) Applicant: TOYOTA JIDOSHA KABUSHIKI KAISHA, Toyota-shi (JP)

(72) Inventors: Aya ONODERA, Nisshin-shi (JP); Akihiko NAKANISHI, Nisshin-shi (JP); Yusuke TSUTSUI, Gifu-ken (JP); Takumi HAMAJIMA, Osaka-shi (JP)

(73) Assignee: TOYOTA JIDOSHA KABUSHIKI KAISHA, Toyota-shi (JP)

(21) Appl. No.: 16/196,287

(22) Filed: Nov. 20, 2018

(30) Foreign Application Priority Data
Nov. 22, 2017 (JP) 2017-224963

(51) Int. Cl. B60L 11/18; G06Q 30/02; G06Q 50/06

(52) U.S. Cl. CPC B60L 11/1848; G06Q 30/0283; B60K 6/28; B60Y 2200/91; G06Q 50/06

(57) ABSTRACT

A management server sends information on a charging card ID of a vehicle that has been charged, position information on a charging equipment where the vehicle is charged, and information on a charged power amount to a fee setting server. The fee setting server identifies a user who has charged the vehicle at the charging equipment by using the information on the charging card ID. The fee setting server compares the position information of the charging equipment received from the management server with the position information of partner facilities stored in a storage device, and determines whether or not the charging equipment is provided by one of the partner facilities. When the charging equipment where the vehicle is charged is a partner facility, the fee setting server applies a partner discount to the EV car sharing fee.

This non-provisional application is based on Japanese Patent Application 2017-224963 filed on Nov. 22, 2017 with the Japan Patent Office, the entire contents of which are hereby incorporated by reference.

### BACKGROUND

### Field

The present disclosure relates to the setting of a car sharing fee for a vehicle such as an electric vehicle traveling by using electric power stored in a power storage device.

### Description of the Background Art

Car sharing which allows a plurality of users to share one vehicle has become increasingly popular. Car sharing means that a user who does not own a vehicle may register as a member of a car sharing company, and thereby may appropriately utilize a vehicle owned by the car sharing company. In recent years, along with the spread of electric vehicles, the electric vehicles are widely used in car sharing.

From the viewpoints of measures against environmental problems such as reducing the amount of CO₂ emissions and alleviation of traffic congestion by decreasing the number of vehicles on road, it is expected to further spread the sharing of electric vehicles (hereinafter also referred to as “EV car sharing”).

Meanwhile, in recent years, stores such as shopping centers and retail shops are taking various measures so as to attract customers who drive cars.

For example, Japanese Patent Laying-Open No. 2003-030695 discloses a parking device which is installed in a parking lot of a store and configured to offer a customer a discount on parking fee if the customer (i) parks his/her vehicle in the store's parking lot, (ii) inserts the parking ticket into a CM generation device installed in the store's parking lot, and (iii) views a piece of commercial advertisement of the store. The parking devices is designed to attract customers for the store by offering a discount on the parking fee based on the act of viewing a piece of commercial advertisement of the store.

### SUMMARY

The parking device disclosed in Japanese Patent Laying-Open No. 2003-030695 promotes the use of vehicles and may be used by any vehicles and private cars other than electric vehicles, but it is not directed to the promotion of EV car sharing.

Therefore, there is a demand for an EV car sharing fee system that links measures implemented by the above-mentioned stores for attracting customers to the promotion of EV car sharing.

The present disclosure has been made to solve the aforementioned problems, and an object thereof is to provide a fee setting system for promoting EV car sharing.

A fee setting server according to the present disclosure is configured to set a sharing fee for a vehicle traveling by using electric power stored in a power storage device. The fee setting server includes: a storage device configured to store position information of partner facilities, each of which is provided with a charging equipment for charging the power storage device; an information acquisition device configured to obtain, from a management server configured to manage the charging equipment or from the vehicle, (i) identification information that is used to identify a user who has charged the vehicle at the charging equipment, (ii) information on a charged power amount of the vehicle, and (iii) position information on the charging equipment where the vehicle is charged; a determination device configured to determine whether or not the vehicle is charged at a partner facility based on the position information of partner facilities and the position information on the charging equipment; and a fee setting device configured to set the sharing fee for the user identified by the identification information based on the information on the charged power amount. The fee setting device sets the sharing fee lower in the case where the vehicle is charged at a partner facility compared with the case where the vehicle is charged not at a partner facility.

A fee setting system according to another aspect of the present disclosure includes a vehicle traveling by using electric power stored in a power storage device, a management server configured to manage a charging equipment for charging the power storage device, and a fee setting server configured to set a sharing fee for the vehicle. The fee setting server is configured to: store position information of partner facilities, each of which is equipped with a charging equipment; obtain, from the management server or from the vehicle, (i) identification information that is used to identify a user who has charged the vehicle at the charging equipment, (ii) information on a charged power amount of the vehicle, and (iii) position information on the charging equipment where the vehicle is charged, determine whether or not the vehicle is charged at a partner facility based on the position information of partner facilities and the position information on the charging equipment; set the sharing fee for the user identified by the identification information based on the information on the charged power amount; and set the sharing fee at lower in the case where the vehicle is charged at a partner facility compared with the case where the vehicle is charged not at a partner facility.

A fee setting method according to still another aspect of the present disclosure is configured to set a sharing fee for a vehicle traveling by using electric power stored in a power storage device. The fee setting method includes: obtaining, from a management server configured to manage the charging equipment or from the vehicle, (i) identification information that is used to identify a user who has charged the vehicle at a charging equipment for charging the power storage device, (ii) information on a charged power amount of the vehicle, and (iii) position information on the charging equipment where the vehicle is charged; determining whether or not the vehicle is charged at a partner facility based on the position information of partner facilities and the position information on the charging equipment; and setting the sharing fee for the user identified by the identification information based on the information on the charged power amount. The sharing fee is set lower in the case where the vehicle is charged at a partner facility compared with the case where the vehicle is charged not at a partner facility.

According to the configuration mentioned above, when an EV car sharing user charges a shared electric vehicle (hereinafter simply referred to as “vehicle” where appropriate) at a partner facility, the sharing fee is set lower compared with the case where the vehicle is charged not at a partner facility. Thereby, by offering the user a benefit for sharing an EV car, the EV car sharing is promoted.

The information on the charged power amount includes information on a charging time, and the fee setting device sets the sharing fee lower as the charging time for the charging performed at the partner facility becomes longer.

According to the configuration mentioned above, since the sharing fee is set lower as the charging time becomes longer, the user is promoted to stay in the partner facility for a longer time, which makes the partner facility to benefit from the fact that the EV car sharing user would utilize the partner facility.

The fee setting device sets the sharing fee at a different price depending on a partner facility where the vehicle is charged.

According to the configuration mentioned above, each partner facility may set a discount rate arbitrarily, and the discount rate can be determined according to the business operation policy of each partner facility.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically illustrating the overall configuration of a fee setting system according to an embodiment of the present disclosure;

FIG. 2 is a diagram illustrating an example of a detailed structure for charging an electric vehicle according to an embodiment of the present disclosure;

FIG. 3 is a functional block diagram illustrating the configuration of a controller included in a fee setting server;

FIG. 4 is a functional block diagram illustrating the configuration of a controller included in a management server;

FIG. 5 is a diagram illustrating an example of a vehicle information list stored in the fee setting server according to an embodiment of the present disclosure;

FIG. 6 is a diagram illustrating an example of a partner facility list stored in the fee setting server according to an embodiment of the present disclosure;

FIG. 7 is a diagram illustrating an example of a charging card ID list stored in the management server according to an embodiment of the present disclosure;

FIG. 8 is a diagram illustrating an example of a charging equipment list stored in the management server according to an embodiment of the present disclosure;

FIG. 9 is a flowchart illustrating a process executed by the fee setting system according to an embodiment of the present disclosure;

FIG. 10 is a functional block diagram illustrating the configuration of a controller included in a fee setting server according to a first modification; and

FIG. 11 is a flowchart illustrating a process executed by the fee setting system according to the first modification.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

(Configuration of Fee Setting System)

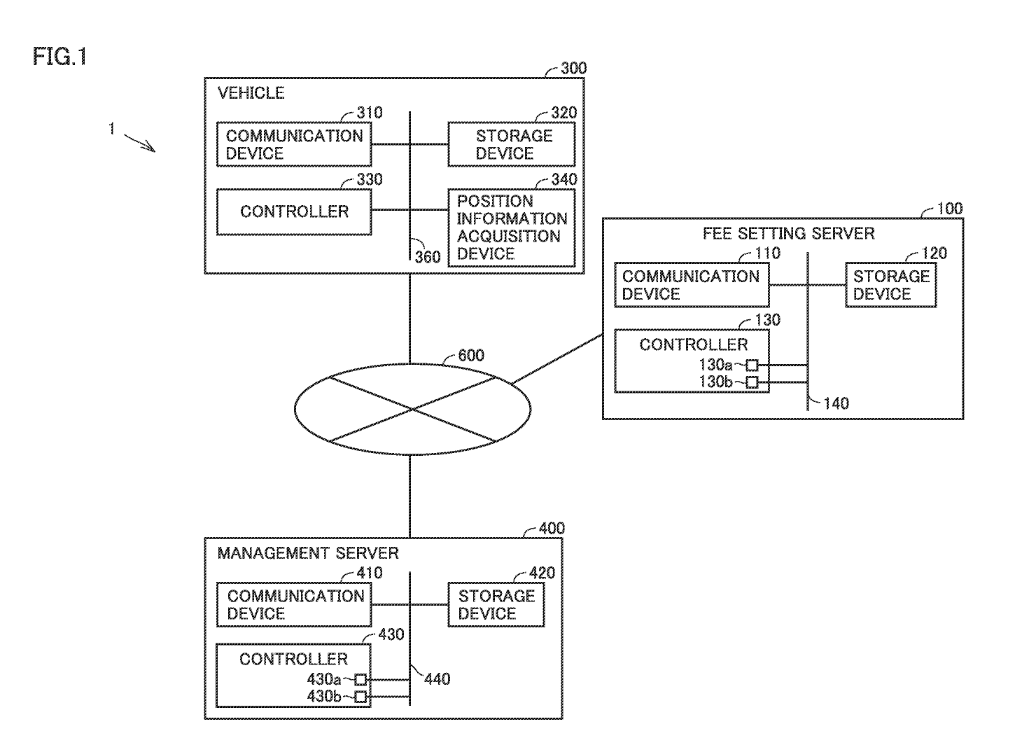

FIG. 1 is a diagram schematically illustrating the overall configuration of a fee setting system 1 according to the present embodiment. As illustrated in FIG. 1, the fee setting system 1 according to the present embodiment includes a fee setting server 100, a vehicle 300 which is an electric vehicle, and a management server 400.

The management server 400 is such a server that is configured to manage public charging equipments and private charging equipments installed at a store or the like (hereinafter simply referred to as “charging equipment” where appropriate) to be used by a user. The charging equipments registered in the network of the management server 400 are collectively managed by the management server 400. A user such as an EV car sharing company or an electric vehicle owner, who wishes to utilize the charging equipment, performs user registration for the charging service provided by a business operator who operates the management server 400. Then, a charging card for performing power charging is issued from the business operator who operates the management server 400. The user performs power charging at a charging equipment with the charging card. The management server 400 authenticates the charging card ID of the charging card and bills the charging card ID for the charging fee at the charging equipment.

The fee setting server 100 includes a communication device 110, a storage device 120 and a controller 130, which are connected by a communication bus 140 so as to communicate with each other.

The communication device 110 is configured to communicate with a communication device 310 of the vehicle 300 and a communication device 410 of the management server 400. The communication between the communication device 110 and the communication device 310 or between the communication device 110 and the communication device 410 is established via a communication network 600 such as the Internet or a telephone line.

The storage device 120 may be a mass storage device such as a hard disk drive or a solid state drive. The storage device 120 stores information of users who are registered as members for sharing electric vehicles (EV car sharing), information of vehicles used in EV car sharing and the like. Further, the storage device 120 stores a vehicle information list 500 which is registered with the reservation status of each vehicle to be used in EV car sharing, and the correlation between each vehicle and the charging card ID of the charging card installed in each vehicle. Furthermore, the storage device 120 stores a partner facility list 550 which includes position information of partner facilities and the like to be described later. The details of the vehicle information list 500 and the partner facility list 550 will be described later.

The controller 130 includes, for example, a CPU (Central Processing Unit) 130a, a memory (including ROM and RAM) 130b, and an input/output port (not shown) for inputting/outputting various signals. The controller 130 is configured to execute a predetermined arithmetic processing based on information stored in the storage device 120 and information received from the vehicle 300 and/or the management server 400 via the communication device 110. The details of the controller 130 will be described later.

The vehicle 300 includes a communication device 310, a storage device 320, a controller 330, and a position information acquisition device 340, which are connected by a communication bus 360 so as to communicate with each other.

The communication device 310 is configured to communicate with the communication device 110 of the fee setting server 100 and the communication device 410 of the management server 400. The communication between the communication device 310 and the communication device 110 or between the communication device 310 and the communication device 410 is established via the communication network 600.

The storage device 320 may be, for example, a storage device such as a nonvolatile memory, a hard disk drive, a solid state drive or the like. The storage device 320 stores, for example, SOC (state of charge) information of a power storage device mounted on the vehicle 300 and position information of the vehicle 300.

The controller 330 includes, for example, a CPU, a memory (including ROM and RAM), and an input/output port (not shown) for inputting/outputting various signals. The controller 330 is configured to execute a predetermined arithmetic processing based on information stored in the memory of the controller 330 or the storage device 320.

Further, the controller 330 monitors the state of the power storage device mounted on the vehicle 300. For example, the controller 330 detects the voltage, current, and temperature of the power storage device, and estimates an open circuit voltage (OCV) from the detected values so as to calculate the SOC of the power storage device. Alternatively, the controller 330 may calculate the SOC of the power storage device by estimating the charged/discharged power amount or the like. Any well-known technique may be used to calculate the SOC, and the detailed description thereof will not be given.

The position information acquisition device 340 is configured to obtain the current position of the vehicle 300. The position information acquisition device 340 obtains the current position of the vehicle 300 from GPS (Global Positioning System), for example. The position information acquisition device 340 sends position information indicating the current position of the vehicle 300 to the controller 330.

The controller 330 stores the calculated SOC information and the position information received from the position information acquisition device 340 in the storage device 320. When the vehicle 300 is in a READY-ON state and the power storage device is being charged, the controller 330 periodically sends the calculated SOC information and the position information obtained by the position information acquisition device 340 to the fee setting server 100. In addition, the controller 330 may send the SOC information and the position information of the vehicle 300 to the fee setting server 100 via the communication device 310 in response to a request from the fee setting server 100. Moreover, the control section 330 may send the SOC information and the position information of the vehicle 300 to the fee setting server 100 via the communication device 310 when the vehicle 300 is shifted from the READY-ON state to the READY-OFF state. Note that the READY-ON state refers to such a state that the vehicle 300 is ready for traveling, and the READY-OFF state refers to such a state that the vehicle 300 is not ready for traveling.

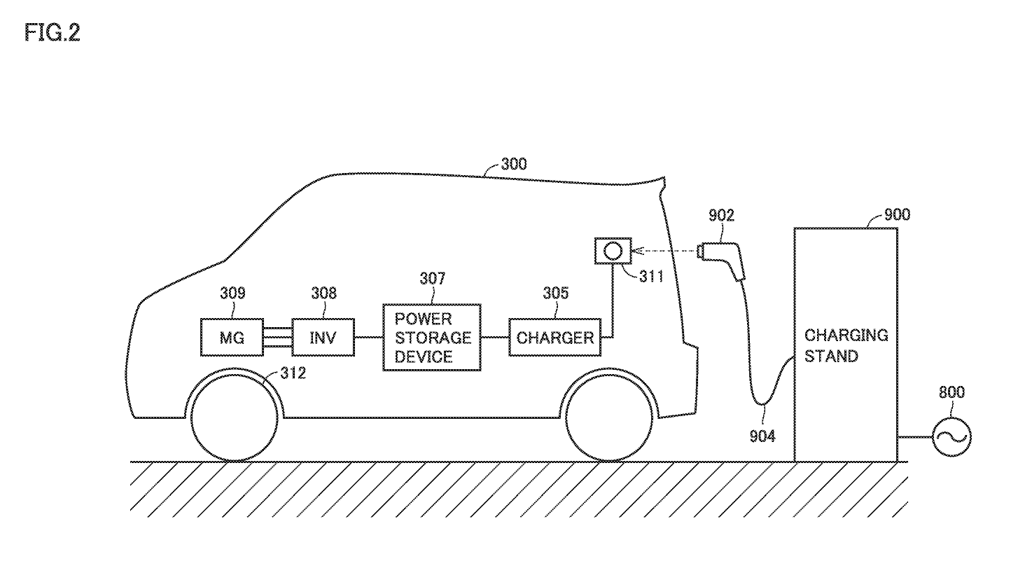

FIG. 2 is a diagram illustrating an example of a detailed structure for charging an electric vehicle according to the present embodiment. Note that in FIG. 2, the communication device 310, the controller 330 and the like illustrated in FIG. 1 are not illustrated.

As illustrated in FIG. 2, the vehicle 300 further includes a charger 305, a power storage device 307, an inverter 308, a motor generator 309, and an inlet 311.

When a charging connector 902 of a charging stand 900 is plugged in the inlet 311, the charger 305 charges the power storage device 307 by using the electric power supplied from an external power source 800.

The power storage device 307 is made of, for example, a secondary battery such as a nickel hydride battery or a lithium ion battery. The power storage device 307 may be any power storage device capable of storing power. For example, the power storage device 307 may be a capacitor having a large capacity.

The inverter 308 is a power conversion device for converting power between AC power and DC power. For example, the inverter 308 converts DC power from the power storage device 307 into AC power and supplies it to the motor generator 309. On the other hand, the inverter 308 converts AC power (regenerative power) from the motor generator 309 into DC power and supplies it to the power storage device 307 so as to charge the power storage device 307.

The motor generator 309 uses power supplied from the inverter 308 to generate a rotational force, and provide it to driving wheels 312. The driving wheels 312 are rotated by the rotational force provided from the motor generator 309 to move the vehicle 300.

The inlet 311 is provided on an exterior portion of the vehicle 300 together with a cover (not shown) such as a lid. The inlet 311 is shaped in such a manner that allows the charging connector 902 to be plugged therein. Both the inlet 311 and the charging connector 902 have contacts built therein. When the charging connector 902 is plugged in the inlet 311, the contacts of the charging connector 902 come into contact with the contacts of the inlet 311, and thereby, the inlet 311 and the charging connector 902 are electrically connected.

The charging station 900 is installed outside the vehicle 300 and is connected to the charging connector 902 via a charging cable 904. The charging station 900 is electrically connected to the power source 800. When the charging connector 902 is plugged in the inlet 311, the power is supplied from the power source 800 through the intermediary of the charging station 900, the charging cable 904 and the charging connector 902 to the vehicle 300.

Returning to FIG. 1, the management server 400 includes a communication device 410, a storage device 420 and a controller 430, which are connected by a communication bus 440 so as to communicate with each other.

The communication device 410 is configured to communicate with the communication device 110 of the fee setting server 100 and the communication device 310 of the vehicle 300. The communication between the communication device 410 and the communication device 110 or between the communication device 410 and the communication device 310 is established via the communication network 600.

The storage device 420 may be a mass storage device such as a hard disk drive or a solid state drive. The storage device 420 stores information of users who are registered for the charging service provided by a business operator who operates the management server 400, position information of charging equipments, information on the charged power amount and the like. Further, the storage device 420 stores a charging card ID list 700 which is registered with a consumed power amount and a charging fee of each charging card ID, and a charging equipment list 750 which is registered with position information and availability information of each charging equipment. The charging card ID list 700 and the charging equipment list 750 will be described later.

The controller 430 includes, for example, a CPU 430a, a memory (including ROM and RAM) 430b, an input/output port (not shown) for inputting/outputting various signals. The controller 430 is configured to execute a predetermined arithmetic processing based on information stored in the storage device 420 and information received from the vehicle 300 via the communication device 410. The details of the controller 430 will be described later.

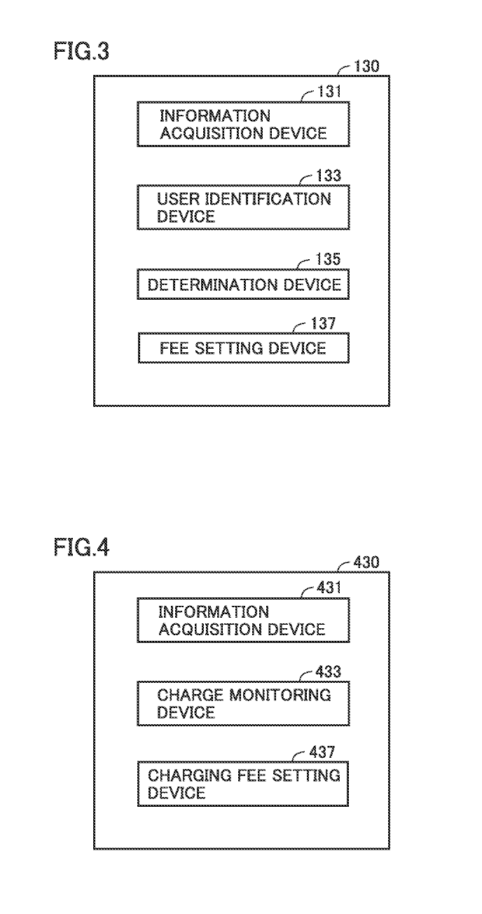

FIG. 3 is a functional block diagram illustrating the configuration of the controller 130 included in the fee setting server 100. The controller 130 includes an information acquisition device 131, a user identification device 133, a determination device 135, and a fee setting device 137.

The information acquisition device 131 obtains, from the management server 400, information on a charging card ID used for identifying a user who has performed charging, position information on the charging equipment where the charging is performed, information on consumed power amount, information on charging time and the like every time after the charging of the vehicle 300 is completed. Note that the information acquisition device 131 may obtain the above information at any time, and may obtain different information at different time.

As described above, the information on the charging card ID is used to identify a user who has registered for the charging service of the business operator who operates the management server 400. The position information on the charging equipment contains information such as longitude and latitude or the like that may be used to specify the position of a charging equipment. The information on consumed power amount includes the amount of power consumed by the vehicle 300 during the charging at the charging equipment. The information on charging time denotes a time interval from the start to the end of charging.

Note that the information on the charging card ID in the present embodiment corresponds to the “identification information” according to the present disclosure, the position information on the charging equipment in the present embodiment corresponds to the “position information” according to the present disclosure, and the information on consumed power amount and the information on charging time in the present embodiment correspond to the “information on a charged power amount” according to the present disclosure.

The user identification device 133 identifies a user who has performed charging based on the charging card ID obtained by the information acquisition device 131. Specifically, the user identification is performed based on the vehicle information list 500 to be described later. The details thereof will be described later.

The determination device 135 compares the position information on the charging equipment obtained by the information acquisition device 131 with the position information of partner facilities stored in the storage device 120. Then, the determination device 135 determines whether or not the charging equipment where the vehicle 300 is charged is a charging equipment provided by a partner facility. Specifically, the determination device 135 determines whether or not the charging equipment where the vehicle 300 is charged is a charging equipment provided by a partner facility based on the partner facility list 550 (to be described later) stored in the storage device 120. The details thereof will be described later.

The fee setting device 137 sets an EV car sharing fee to be billed from a user who shares the vehicle 300. The fee setting device 137 determines the EV car sharing fee according to whether or not the user has charged the vehicle 300 at a partner facility. The setting of the sharing fee will be described later in detail.

FIG. 4 is a functional block diagram illustrating the configuration of the controller 430 included in the management server 400. The controller 430 includes an information acquisition device 431, a charge monitoring device 433, and a charging fee setting device 437.

Upon receiving from a charging equipment a signal indicating that a charging card is authenticated in the charging equipment or the like, the information acquisition device 431 obtains the information on the charging card ID and the position information on the charging equipment from the charging equipment. Further, the information acquisition device 431 obtains start-of-charging information indicating the initiation of the charging from the charging equipment, and sends a notification indicating the reception of the start-of-charging information to the charging monitoring device 433. Moreover, the information acquisition device 431 obtains from the charging equipment end-of-charging information indicating the completion of the charging, and sends a notification indicating the reception of the end-of-charging information to the charging monitoring device 433.

Upon receiving the notification indicating the reception of the start-of-charging information from the information acquisition device 431, the charge monitoring device 433 starts to monitor the charging. Upon receiving the notification indicating the reception of the end-of-charging information from the information acquisition device 431, the charging monitoring device 433 stops monitoring the charging. The charge monitoring device 433 calculates the power amount used for the current charging. Further, the charge monitoring device 433 calculates the charging time during which the charging was performed. The charge monitoring device 433 calculates a period of time from a time at which the notification indicating the reception of the start-of-charging information is received to a time at which the notification indicating the reception of the end-of-charging information is received as the charging time. In general, the more the amount of electric power is used for charging, the longer the charging time will be.

The charging fee setting device 437 sets a charging fee to be billed from the user who has charged the vehicle 300. The charging fee setting device 437 calculates the charging fee based on the power amount calculated by the charging monitoring device 433 and the power unit price, and registers it in the charging card ID list 700 to be described later.

(EV Car Sharing)

In recent years, along with the spread of electric vehicles, the electric vehicles are widely used in car sharing. From the viewpoints of measures against environmental problems such as reducing the amount of CO2 emissions and alleviation of traffic congestion by decreasing the number of vehicles, it is expected to further spread the EV car sharing.

Meanwhile, stores such as shopping centers and retail shops are taking various measures so as to attract customers who drive cars. However, the measures for attracting customers, which are implemented at the stores mentioned above, are mainly aimed for promoting the use of all vehicles, not for the promotion of the EV car sharing.

Therefore, there is a demand for an EV car sharing fee system that links measures implemented by the above-mentioned stores for attracting customers to the promotion of EV car sharing.

In the present embodiment, the fee setting server 100 receives the information on the charging card ID, the position information on the charging equipment where the vehicle 300 is charged, the information on consumed power amount, the information on charging time and the like from the management server 400. The fee setting server 100 identifies the vehicle 300 by comparing the information on the charging card ID with the vehicle information list 500 to be described later, and thereby identifies the user who is using the vehicle 300.

Then, the fee setting server 100 determines whether or not the charging equipment where the vehicle 300 is charged is one of the partner facilities by comparing the position information on the charging equipment where the vehicle 300 is charged with the position information of partner facilities stored in the storage device 120.

If it is determined that the charging equipment where the vehicle 300 is charged is a partner facility, the fee setting server 100 applies a partner discount to the EV car sharing fee.

Further, the fee setting server 100 sets the partner discount rate larger as the charging time for the charging performed at the partner facility is longer.

Thus, when a user who utilizes the EV car sharing charges a shared vehicle 300 at a partner facility, a partner discount is applied and thereby, the sharing fee is set lower compared with the case where the vehicle 300 is charged not at the partner facility. Thereby, by offering the user a benefit for sharing an EV car, the EV car sharing is promoted.

In addition, the longer the charging time is, the larger the partner discount rate is, and thereby, the lower the sharing fee will be. As a result, the user is promoted to stay in the partner facility for a longer time, which makes the partner facility to benefit from the fact that the EV car sharing user would utilize the partner facility.

(Vehicle Information List)

FIG. 5 is a diagram illustrating an example of the vehicle information list 500 stored in the fee setting server 100 according to the present embodiment. As illustrated in FIG. 5, in the present embodiment, the vehicle information list 500 is registered with a charging card ID and a reservation status in each time slot for each vehicle information.

The vehicle information is used to identify a vehicle. For example, the vehicle information may be a chassis number or the like. In the present embodiment, for simplicity of explanation, the vehicles are identified as vehicle A, vehicle B or the like based on the vehicle information.

The charging card ID is a card ID of a charging card issued by a business operator who operates the management server 400 when a user makes a user registration so as to allow the user to charge at a charging equipment operated by the same business operator. In the EV car sharing according to the present embodiment, a specific charging card ID is linked by the EV car sharing company to a specific vehicle. A plurality of charging card IDs may be linked to one vehicle. A user who is using the vehicle uses a charging card installed in the vehicle to charge the vehicle at a charging equipment.

In the reservation status, the reservation time is divided into time slots every hour, and if a user makes a reservation in one time slot, that time slot is registered with a user ID. After a user has registered in the EV car sharing, a user ID is set for the user and used to identify the user. In the present embodiment, the time slots are divided as 0:00 to 1:00, 1:00 to 2:00, and the like.

For example, a charging card having a charging card ID of A-1 is installed in vehicle A, and vehicle A is reserved by a user having a user ID of 001 in a time slot from 0:00 to 1:00 and another time slot from 1:00 to 2:00. Similarly, a charging card having a charging card ID of B-1 is installed in vehicle B, and vehicle B is reserved by a user having a user ID of 003 in a time slot from 23:00 to 0:00, a charging card having a charging card ID of C-1 is installed in vehicle C, and vehicle C is reserved by a user having a user ID of 002 in a time slot from 0:00 to 1:00.

In the vehicle information list 500 according to the present embodiment, the reservation time is divided into time slots every hour as described above, but each time slot is not limited to one hour. For example, each time slot may be two hours or 30 minutes. Alternatively, the reservation time may not be divided into time slots, and thereby, the user may make reservations at any time.

(Partner Facility List)

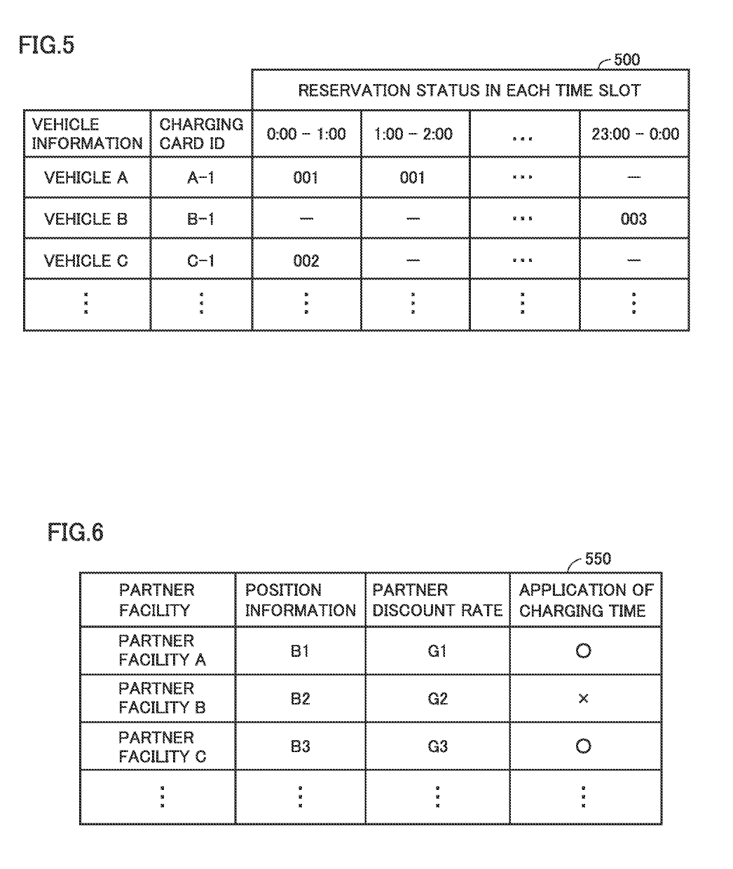

FIG. 6 is a diagram illustrating an example of the partner facility list 550 stored in the fee setting server 100 according to the present embodiment. As illustrated in FIG. 6, in the present embodiment, the partner facility list 550 is registered with a partner facility, position information, a partner discount rate, and application of charging time.

The partner facility is a facility that is in cooperation with the EV car sharing company. The partner facility may be, for example, a shopping mall, a retail shop, a sports gym, a game center or the like.

The position information is for specifying the position of a partner facility. The position information may be, for example, longitude and latitude or the like.

The partner discount rate is a discount rate of a partner discount determined by each partner facility. The partner discount rate may be arbitrarily set by each partner facility. In general, the partner discount rate may be set in consideration of the balance between the customer attraction effect and budget. For example, different discount rates may be set depending on different seasons in a year and different days in a week. Partner facilities may attract customers by offering a partner discount and a partner discount rate.

In the present embodiment, the partner discount rate may be arbitrarily set by each partner facility, and it is acceptable that the partner discount rate may be arbitrarily set by each partner facility within a certain range defined by the EV car sharing company, preventing unfair competition from occurring among partner facilities by offering excessively low discount rates. It is also acceptable that the discount rate is identical for all of the partner facilities.

The application of charging time indicates whether or not the charging time is accounted in the partner discount rate. For a facility with a mark “0” listed in the column of “application of charging time”, the partner discount rate is set larger in accordance with the charging time. Specifically, in the case of the partner facility A, as the charging time becomes longer, the discount rate is set larger relative to the discount rate G1. In the facility with a mark “X” listed in the column of “application of charging time”, the charging time is not accounted in the partner discount rate. Specifically, in the case of the partner facility B, the discount rate G2 is applied regardless of the charging time.

As a specific example of setting the partner discount rate larger in accordance with the charging time, for example, when the charging time is 15 minutes or more and less than 30 minutes, the partner discount applied to the EV car sharing fee is 5%, and when the charging time is 30 minutes or more and less than 1 hour, the partner discount applied to the EV car sharing fee is 10%.

Depending on the business types of partner facilities, some facilities may wish customers to stay for a longer time, while some facilities may wish to increase the turnover rate of customers. If the charging time is applied, the customers may be promoted to stay in the partner facilities for a longer time, while if the charging time is not applied, the turnover rate of customers may be promoted.

As an example, the partner facility A has position information B1 and offers a partner discount rate G1, to which the charging time is applied. The partner facility B has position information B2 and offers a partner discount rate G2, to which the charging time is not applied.

(Charging Card ID List)

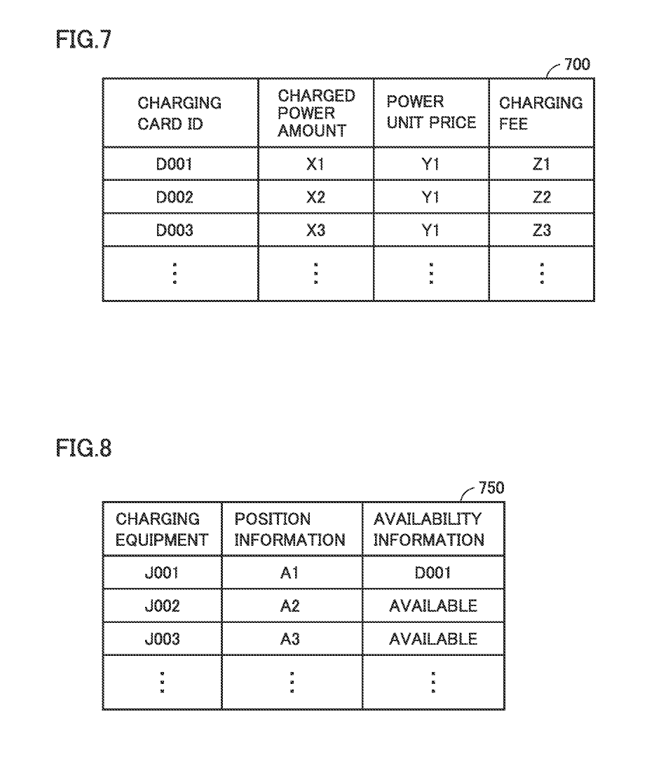

FIG. 7 is a diagram illustrating an example of the charging card ID list 700 stored in the management server 400 according to the present embodiment. As illustrated in FIG. 7, in the present embodiment, the charging card ID list 700 is registered with the charged power amount, the power unit price and the charging fee for each charging card ID.

The power amount consumed by the charging performed by using the charging card ID is registered as the charged power amount. The charged power amount is the sum of power consumed by the charging performed by using the charging card ID each time.

The power unit price is a price for unit power. The power unit price is set for each specific period to be described later and registered in the charging card ID list 700. In the present embodiment, the power unit price is set identical for all users, but it is not limited thereto, and the power unit price may be different for each user.

The charging fee is calculated by multiplying the charged power amount and the power unit price. For example, the charging fee is calculated every specific period. The specific period may be set arbitrarily, it may be, for example, half a month, 1 month, 6 months or the like. Note that the consumed power amount, the power unit price and the charging fee may be reset every specific period.

As an example, for a user having a charging card ID of D001, the charged power amount is X1, the power unit price is Y1, and the charging fee is Z1 (=X1×Y1).

(Charging Equipment List)

FIG. 8 is a diagram illustrating an example of the charging equipment list 750 stored in the management server 400 according to the present embodiment. As illustrated in FIG. 8, in the present embodiment, the charging equipment list 750 is registered with position information and availability information for each charging equipment.

Each charging equipment is registered in the network of the management server 400. In the present embodiment, the user who has registered for the charging service provided by the business operator who operates the management server 400 uses the charging card ID to access each charging equipment.

The position information is for specifying the position where a charging equipment is installed. The position information may, for example, longitude and latitude.

Whether a charging equipment is in use or vacant is registered as the availability information. If the charging equipment is in use, the charging card ID of a vehicle occupying the charging equipment is registered in the column of availability information. When a charging equipment is vacant, the availability information is registered as “Available”.

As an example, for a charging equipment J001, it is registered with the position information A and is occupied by a vehicle having a charging card ID of D001. For a charging equipment J002, it is registered with the position information B, and is available currently.

(Fee Setting Method)

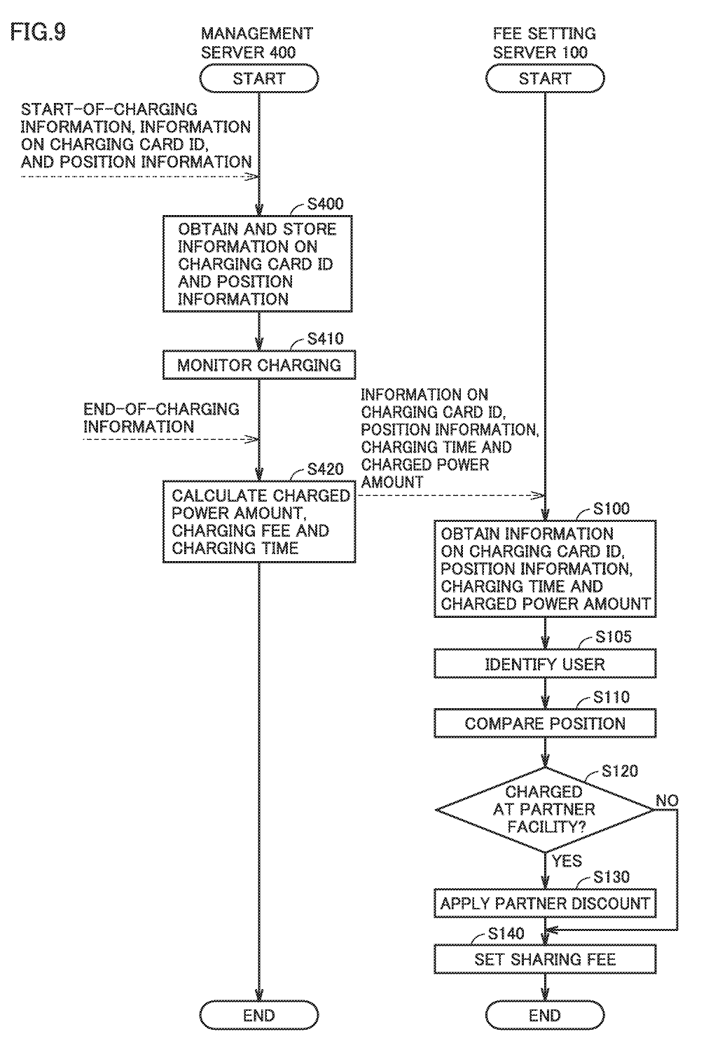

FIG. 9 is a flowchart illustrating a process executed by the fee setting system 1 according to the present embodiment. The process is executed every time when the vehicle 300 is charged at a charging equipment registered in the network of the management server 400. Each step of the flowchart illustrated in FIG. 9 is executed by software included in the fee setting server 100 or the management server 400, but a part of the steps may be executed by hardware (such as an electric circuit) provided in the fee setting server 100 or the management server 400.

After a user has the charging card ID authenticated in a charging equipment and starts to charge the vehicle 300, the management server 400 obtains start-of-charging information, a charging card ID, and position information on the charging equipment from the charging equipment (S400). Then, the management server 400 stores the obtained information in the storage device 420, and registers the charging card ID in the column of availability information in the charging equipment list 750 (S400).

The management server 400 monitors the charging performed in the charging equipment (S410), and terminates the monitoring of the charging after receiving end-of-charging information from the charging equipment. Then, the management server 400 calculates the charged power amount for the current charging and registers it in the charging card ID list 700. The management server 400 calculates the charging fee for the current charging and registers it in the charging card ID list 700 (S420). In addition, the management server 400 calculates the charging time for the current charging based on the start-of-charging information and the end-of-charging information, and stores the charging time in the storage device 420 in association with the charging card ID (S420).

The management server 400 sends the charging card ID, the position information on the charging equipment where the charging is performed, the charged power amount and the charging time to the fee setting server 100. The fee setting server 100 obtains from the management server 400 the charging card ID, the position information on the charging equipment where the charging is performed, the charged power amount and the charging time (S100).

The fee setting server 100 reads the vehicle information list 500 from the storage device 120 and compares the obtained charging card ID with the list. For example, if the obtained charging card ID is A-1, the fee setting server 100 determines that a vehicle where the charging card ID of A-1 is installed is vehicle A by referring to the vehicle information list 500. Then, the fee setting server 100 identifies the ID of a user who has performed the charging based on the time slot in which the charging was performed (S105).

The fee setting server 100 compares the position information, which is obtained from the management server 400, of the charging equipment where the charging has been performed with the position information of partner facilities in the partner facility list 550 read from the storage device 120 (S110). Then, the fee setting server 100 determines whether or not the charging equipment where the charging has been performed is a charging equipment provided by any of the partner facilities based on the comparison result (S120).

If the charging equipment where the charging has been performed is not a charging equipment provided by any of the partner facilities (NO at S120), the fee setting server 100 sets the sharing fee without applying the partner discount (S140).

If the charging equipment where the charging has been performed is a charging equipment provided by a partner facility (YES at S120), the fee setting server 100 applies a partner discount (S130) and sets the sharing fee (S140). Specifically, the fee setting server 100 applies the partner discount based on the partner facility list 550. The fee setting server 100 sets the sharing fee by applying a discount rate determined by the partner facility where the charging has been performed.

If the charging time discount should be applied at S130, the fee setting server 100 applies the partner discount in accordance with the charging time obtained from the management server 400.

If the vehicle 300 is charged at a charging equipment provided by a partner facility for a plurality of times, it is acceptable that the fee setting server 100 may set the sharing fee after a plurality of times of charging. For example, the fee setting server 100 may set the sharing fee after receiving, from the vehicle 300, end-of-service information indicating that the vehicle has been returned.

As described above, in the present embodiment, when a user who utilizes the EV car sharing performs the charging at a charging equipment provided by a partner facility, a partner discount is applied to the EV car sharing fee. Thereby, by offering the user a benefit for sharing an EV car, the EV car sharing is promoted.

In addition, the longer the charge time of the charging performed at a partner facility is, the greater the partner discount rate will be. Thereby, the user is promoted to stay in the partner facility for a longer time, which makes the partner facility to benefit from the fact that the EV car sharing user would utilize the partner facility.

In the present embodiment, the description has been carried out by assuming that the vehicle 300 is an electric vehicle, but it is not limited thereto, the vehicle may be a plug-in hybrid vehicle provided with a power storage device. By applying the present disclosure to a plug-in hybrid vehicle, it is possible to promote the use of a plug-in hybrid vehicle in the same way as the electric vehicle described in the present embodiment.

<First Modification>

In the embodiment of the present disclosure, the fee setting server 100 obtains the “identification information”, the “information on a charged power amount” and the “position information” in the present disclosure from the management server 400, but it is not limited thereto. For example, the fee setting server 100 may obtain the “identification information”, the “information on a charged power amount” and the “position information” described in the present disclosure from the vehicle 300. In the first modification, an example of obtaining the above information from the vehicle 300 will be described.

The fee setting system 1 according to the first modification is substantially the same as the fee setting system 1 according to the embodiment of the present disclosure except the configuration of a controller included in the fee setting server. Hereinafter, the description will be carried out only on a controller 130A of the fee setting server 100 according to the first modification without repeating the contents described in the above.

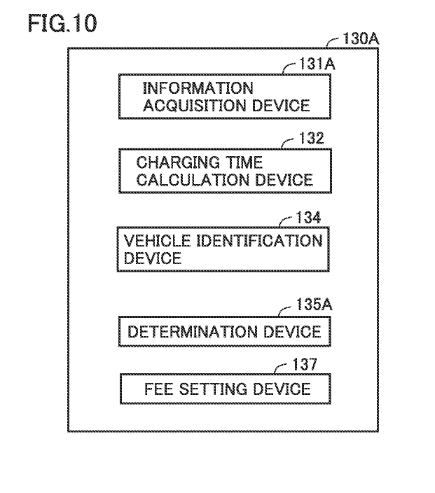

FIG. 10 is a functional block diagram illustrating the configuration of the controller 130A included in the fee setting server 100 according to the first modification. The controller 130A includes an information acquisition device 131A, a charging time calculation device 132, a vehicle identification device 134, a determination device 135A, and a fee setting device 137.

The information acquisition device 131A obtains start-of-charging information and end-of-charging information from the vehicle 300. Further, the information acquisition device 131A obtains vehicle information for identifying the vehicle 300, vehicular position information and vehicular SOC information from the vehicle 300 while obtaining the start-of-charging information. Furthermore, the information acquisition device 131A obtains the SOC information of the vehicle from the vehicle 300 while obtaining the end-of-charging information.

The vehicle information may be a chassis number or the like assigned to each vehicle for identifying the vehicle. The vehicle identification device 134 compares the vehicle 300 identified by using the vehicle information with the vehicle information list 500, thereby identifies the user who is using the vehicle 300.

The vehicular position information is the position information of the vehicle 300 obtained by the position information acquisition device 340 of the vehicle 300. The vehicular SOC information is information indicating the current SOC of the vehicle 300 calculated by the controller 330 of the vehicle 300.

The vehicle information according to the first modification corresponds to the “identification information” according to the present disclosure. Further, the vehicular position information according to the first modification corresponds to the “position information” according to the present disclosure. Furthermore, the vehicular SOC information according to the first modification corresponds to the “information on a charged power amount” according to the present disclosure.

The charging time calculation device 132 calculates the charging time during which the vehicle 300 is charged. Specifically, for example, the charging time of the vehicle 300 is calculated by using the start-of-charging information and the end-of-charging information obtained by the information acquisition device 131A.

As described above, the vehicle identification device 134 identifies the vehicle 300 by using the vehicle information obtained by the information acquisition device 131A.

The determination device 135A compares the vehicular position information obtained by the information acquisition device 131A with the position information of partner facilities (the partner facility list 550) stored in the storage device 120 so as to determine whether or not the charging equipment where the vehicle 300 is charged is a charging equipment provided by the partner facility.

The fee setting device 137 sets an EV car sharing fee to be billed from a user who shares the vehicle 300. The fee setting device 137 determines the EV car sharing fee according to whether or not the user has charged the vehicle 300 at a partner facility.

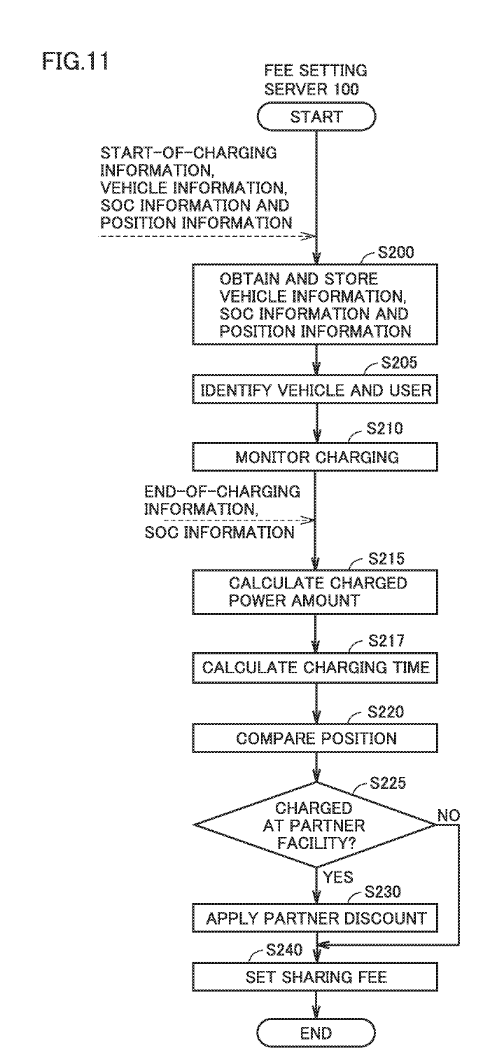

FIG. 11 is a flowchart illustrating a process executed by the fee setting system 1 according to the first modification. The process is performed every time when the vehicle 300 for EV car sharing is charged. Each step of the flowchart illustrated in FIG. 11 is executed by software included in the fee setting server 100 or the management server 400, but a part of the steps may be executed by hardware (such as an electric circuit) provided in the fee setting server 100 or the management server 400.

After a user has the charging card ID authenticated in a charging equipment and starts to charge the vehicle 300, the vehicle 300 sends the start-of-charging information, the vehicle information, the SOC information of the vehicle 300, the position information of the vehicle 300 to the fee setting server 100 (S500).

The fee setting server 100 obtains the start-of-charging information, the vehicle information, the SOC information of the vehicle 300 and the position information of the vehicle 300 from the vehicle 300, and stores the vehicle information, the SOC information of the vehicle 300 and the position information of the vehicle 300 in the storage device 120 (S200).

The fee setting server 100 identifies the vehicle 300 by using the vehicle information. Then, the fee setting server 100 reads the vehicle information list 500 from the storage device 120 and identifies the user who is using the vehicle 300 (S205).

The fee setting server 100 monitors the charging at the charging equipment (S210), and terminates the monitoring of charging upon obtaining the end-of-charging information from the vehicle 300. The fee setting server 100 obtains the SOC information of the vehicle 300 while obtaining the end-of-charging information from the vehicle 300.

The fee setting server 100 calculates the charged power amount for the current charging from the charge-monitoring result (S215). Specifically, the charged power amount is calculated from the initial SOC of the power storage device when the charging of the vehicle 300 is initiated and the final SOC of the power storage device when the charging of the vehicle 300 is completed.

The fee setting server 100 calculates the charging time during which the vehicle 300 is charged based on the start-of-charging information and the end-of-charging information (S217).

The fee setting server 100 compares the position information, which is obtained from the vehicle 300, of the charging equipment where the charging has been performed with the position information of partner facilities in the partner facility list 550 read from the storage device 120 (S220). Then, the fee setting server 100 determines whether or not the charging equipment where the charging has been performed is a charging equipment provided by any of the partner facilities based on the comparison result (S225).

If the charging equipment where the charging has been performed is not a charging equipment provided by any of the partner facilities (NO at S120), the fee setting server 100 sets the sharing fee without applying the partner discount (S240).

If the charging equipment where the charging has been performed is a charging equipment provided by a partner facility (YES at S225), the fee setting server 100 applies a partner discount (S230) and sets the sharing fee (S240). Specifically, the fee setting server 100 applies the partner discount based on the partner facility list 550. The fee setting server 100 sets the sharing fee by applying a discount rate defined by the partner facility where the charging has been performed.

If the charging time discount should be applied at S230, the fee setting server 100 applies the partner discount in accordance with the charging time calculated at S217.

As described above, in the first modification, the fee setting server 100 obtains the vehicle information (identification information), vehicular position information (position information), and the SOC information (information on a charged power amount) from the vehicle 300. Similar to the embodiment, in the first modification, when an EV car sharing user has performed the charging at a charging equipment provided by a partner facility, a partner discount is applied to the EV car sharing fee. Thereby, by offering the user a benefit for sharing an EV car, the EV car sharing is promoted.

In addition, the longer the charge time of charging performed at a charging equipment provided by a partner facility is, the greater the partner discount rate will be. Thereby, the user is promoted to stay in the partner facility for a longer time, which makes the partner facility to benefit from the fact that the EV car sharing user would utilize the partner facility.

<Second Modification>

In the embodiment of the present disclosure, the fee setting server 100 obtains the “identification information”, the “information on a charged power amount” and the “position information” in the present disclosure from the management server 400; in the first modification, the fee setting server 100 obtains the “identification information”, the “information on a charged power amount” and the “position information” in the present disclosure from the vehicle 300. However, it is not necessary for the fee setting server 100 to obtain all of the “identification information”, the “information on a charged power amount” and the “position information” from the management server 400 or from the vehicle 300. The fee setting server 100 may obtain a part of the information from the management server 400 and the other part of the information from the vehicle 300. For example, the fee setting server 100 may obtain the “identification information”, the “information on a charged power amount” from the management server 400 and obtain the “position information” from the vehicle 300.

The embodiments disclosed herein are illustrative and non-restrictive in any respect. The technical scope indicated by the claims is intended to include any modifications within the scope and meaning equivalent to the terms of the claims.

What is claimed is:

1. A fee setting server configured to set a sharing fee for a vehicle traveling by using electric power stored in a power storage device, comprising:
a storage device configured to store position information of partner facilities, each of which is provided with a charging equipment for charging the power storage device;
an information acquisition device configured to obtain, from a management server configured to manage the charging equipment or from the vehicle, (i) identification information that is used to identify a user who has charged the vehicle at the charging equipment, (ii) information on a charged power amount of the vehicle, and (iii) position information on the charging equipment where the vehicle is charged;
a determination device configured to determine whether or not the vehicle is charged at a partner facility based on the position information of partner facilities and the position information on the charging equipment; and
a fee setting device configured to set the sharing fee for the user identified by the identification information based on the information on the charged power amount,
the fee setting device is configured to set the sharing fee lower in the case where the vehicle is charged at a partner facility compared with the case where the vehicle is charged not at a partner facility.

2. The fee setting server according to claim 1, wherein
the information on the charged power amount includes information on a charging time,
the fee setting device is configured to set the sharing fee lower as the charging time for the charging performed at the partner facility becomes longer.

3. The fee setting server according to claim 1, wherein
the fee setting device is configured to set the sharing fee at a different price depending on a partner facility where the vehicle is charged.

4. A fee setting system comprising:
a vehicle traveling by using electric power stored in a power storage device;
a management server configured to manage a charging equipment for charging the power storage device; and
a fee setting server configured to set a sharing fee for the vehicle,
the fee setting server being configured to
store position information of partner facilities, each of which is equipped with a charging equipment,
obtain, from the management server or from the vehicle, (i) identification information that is used to identify a user who has charged the vehicle at the charging equipment, (ii) information on a charged power amount of the vehicle, and (iii) position information on the charging equipment where the vehicle is charged,
determine whether or not the vehicle is charged at a partner facility based on the position information of partner facilities and the position information on the charging equipment,
set the sharing fee for the user identified by the identification information based on the information on the charged power amount, and
set the sharing fee lower in the case where the vehicle is charged at a partner facility compared with the case where the vehicle is charged not at a partner facility.

5. A method for setting a sharing fee for a vehicle traveling by using electric power stored in a power storage device, comprising:
obtaining, from a management server configured to manage the charging equipment or from the vehicle, (i) identification information that is used to identify a user who has charged the vehicle at a charging equipment for charging the power storage device, (ii) information on a charged power amount of the vehicle, and (iii) position information on the charging equipment where the vehicle is charged;
determining whether or not the vehicle is charged at a partner facility based on the position information of partner facilities and the position information on the charging equipment; and
setting the sharing fee for the user identified by the identification information based on the information on the charged power amount,
the sharing fee being set lower in the case where the vehicle is charged at the partner facility compared with the case where the vehicle is charged not at a partner facility.
